(19) United States
(12) Patent Application Publication
(10) Pub. No.: US 2019/0377374 A1
(43) Pub. Date: Dec. 12, 2019

(54) THERMOSTAT RELAY DEVICE

(71) Applicant: RCS Technology, LLC, Poway, CA (US)

(72) Inventor: Michael Hoffman, San Diego, CA (US)

(21) Appl. No.: 16/002,562

(22) Filed: Jun. 7, 2018

(51) Int. Cl. G05D 23/19; F24F 11/30; H04L 12/28; F24F 11/50

(52) U.S. Cl. CPC G05D 23/1905; F24F 11/30; F24F 2110/10; H04L 12/282; F24F 11/50; H04L 12/2818

(57) ABSTRACT

A thermostat relay device is described. The thermostat relay device provides a communication link to a battery-powered thermostat that allows the battery-powered thermostat to transmit and receive wireless communication signals while maintaining long battery life.

### BACKGROUND

### I. Field of Use

The present application relates to the field of heating, ventilation and air conditioning (HVAC). More specifically, the present application relates to wireless communications with thermostats.

### II. Description of the Related Art

Wireless thermostats have become commonplace, found in millions of homes in the United States alone. Such wireless thermostats typically rely on the 802.11 Wi-Fi standard to communicate with fixed and mobile devices via a home Wi-Fi network. While this is a convenient means to allow wireless setup and control of such thermostats, Wi-Fi typically requires a wired source of power. This is because Wi-Fi transceivers typically drawn too much power to sustain batteries for any meaningful length of time. In some instances, where a wireless, Wi-Fi thermostat replaces a traditional thermostat, a source of power is not an issue, because traditional thermostats typically rely on a source of power that is received from a transformer located on the HVAC equipment. Wi-Fi-based thermostats are generally designed to use this source of power.

However, when no source of power is available, such as when a thermostat is being installed in a location where no previous thermostat has existed, generally, there is no wired power readily available for the thermostat.

It would be desirable to enable wireless communications in a battery-powered thermostat without quickly depleting the batteries.

### SUMMARY

The embodiments described herein relate to a thermostat relay device and method. In one embodiment, a thermostat relay device performs operations of wirelessly receiving, by a processor via a receiver coupled to the processor, a thermostatic command from a local-area network, the thermostat command received in accordance with a local-area wireless communication protocol, the thermostatic command for causing a battery-operated thermostat to perform an action, and transmitting, by the processor via a low-power transmitter coupled to the processor, the thermostatic command using a low-energy wireless communication protocol to the battery-powered thermostat located within range of the low-power transmitter.

In another embodiment, a thermostat relay device is described, comprising a memory for storing processor-executable instructions, a receiver for wirelessly receiving a thermostatic command in accordance with a local-area wireless communication protocol, and a low-power transmitter for transmitting a thermostatic response in accordance with a low-energy wireless communication protocol, and a processor coupled to the memory, the receiver and the low-power transmitter for executing the processor-executable instructions that causes the thermostatic relay device to wirelessly receive, by the processor via the receiver, the thermostatic command from a local-area network, the thermostat command received in accordance with the local-area wireless communication protocol, the thermostatic command for causing a battery-operated thermostat to perform an action, and transmit, by the processor via the low-power transmitter, the thermostatic command using the low-energy wireless communication protocol to the battery-powered thermostat located within range of the low-power transmitter.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a top, plan view of one embodiment of a home comprising a local-area network, a thermostat relay device, a battery-powered thermostat, and an HVAC system;

FIG. 2 is a front, plan view of the thermostat relay device and thermostat as shown in FIG. 1, mounted on a wall;

FIG. 3 is a functional block diagram of one embodiment of the thermostat relay device as shown in FIGS. 1 and 2;

FIG. 4 is a functional block diagram of one embodiment of the thermostat as shown in FIGS. 1 and 2; and

FIG. 5 is a flow diagram illustrating one embodiment of a method performed by the thermostat and thermostat relay device as shown in FIGS. 1-4.

### DETAILED DESCRIPTION

The present description relates to a battery-powered, thermostat relay device for enabling wireless communication with a battery-powered thermostat without quickly depleting the batteries used in the thermostat.

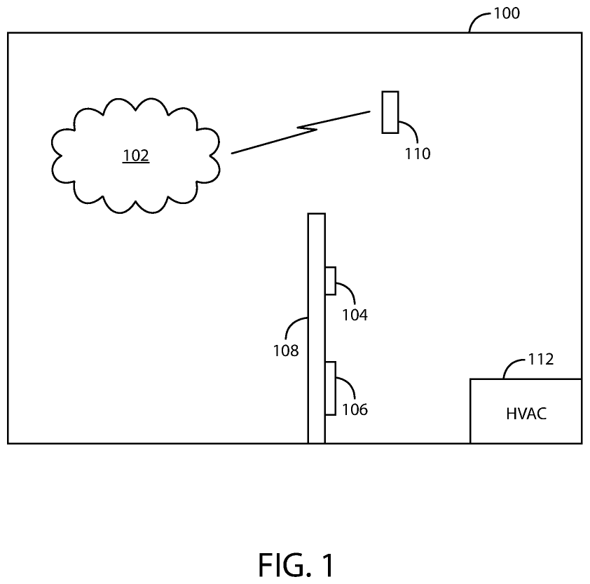

FIG. 1 is a top, plan view of one embodiment of a home 100 comprising local-area network 102, thermostat relay device 104, battery-powered thermostat 106, and HVAC 112. In this embodiment, home 100 comprises a single thermostat 106 mounted to wall 108 which controls heating and/or air conditioning of home 100 via control of HVAC 112, and thermostat relay device 104 is mounted in proximity to thermostat 106. Wireless communications may be provided between thermostat 106 and an end-device 110, such as a mobile phone, tablet computer, wearable device, mobile or desktop computer, etc. via thermostat relay device 104 and local-area network 102. In addition, end-devices may communicate with thermostat 106 remotely from home 100 over the Internet. In one embodiment, thermostat 106 communicates wirelessly with thermostat relay device 104 using a low-energy wireless communication protocol but is incapable of communicating directly with local-area network 102. In other embodiments, thermostat 106 is capable of communication directly with either thermostat relay device 104 or local-area network 102. In these embodiments, thermostat 106 may be powered by a constant source of power, such as standard 110-120 VAC as used in most homes in the United States, if such a constant source of power is available for thermostat 106.

Local-area network 102 typically comprises a high-speed modem and a router for providing Internet service to home 100 and for providing local, wireless connectivity to the Internet to end-devices located in and around home 100.

HVAC 112 comprises heating and/or air conditioning equipment commonly found in almost every home in the United States. For example, HVAC 112 could comprise a combination of a natural gas, forced-air heater coupled with a central air conditioning unit and related ducting.

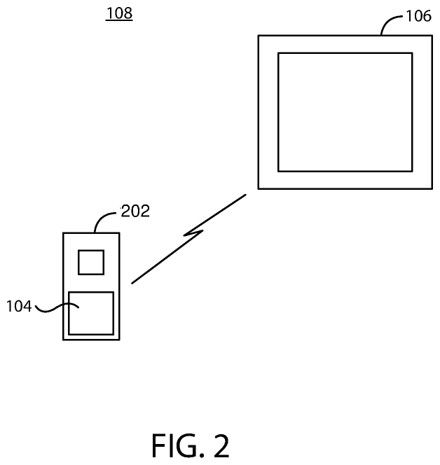

FIG. 2 is a front, plan view of thermostat relay device 104 and thermostat 106 mounted on wall 108. Thermostat relay device 104 is shown mounted to outlet 200 via prongs that extend from a housing surface of thermostat relay device 104. The prongs receive AC power from outlet 200, which supplies a constant source of 110-120 VAC power to thermostat relay device 104 or other electric devices. Thermostat relay device 104 uses the power from outlet 200 in order to power electronic circuitry located inside thermostat relay device 104. As such, thermostat relay device 104 is able to support power-intensive circuitry, such as Wi-Fi circuitry, that is typically contained within thermostat relay device 104.

As mentioned previously, thermostat relay device 104 communicates wirelessly with local-area network 102 via well-known communication circuitry and protocols, such as one of a number of variations of IEEE 802.11, commonly known as Wi-Fi. In other embodiments, thermostat relay device 104 may comprise, alternatively or in addition to wireless communication circuitry, well-known power-line communication circuitry for communicating with local-network 102 via standard household AC wiring that is used to provide power throughout home 100.

Thermostat relay device 104 also communicates with thermostat 106, using different communications circuitry and a different wireless communication protocol that what is used to communicate with local-area network. In one embodiment, the circuitry and communication protocol comprises the well-known Bluetooth Low-Energy protocol and related circuitry. In other embodiments, some other low power-consuming wireless communication circuitry and protocol may be used, typically chosen based on power requirements of thermostat 106. Examples of such low-power wireless circuitry and protocols include Zigbee®, RF4CE, and others.

Thermostat 106 is battery-operated and comprises low-power, wireless communication circuitry that allows thermostat 106 to operate for a “long” time period before needing a battery change, typically on the order of one or more years. In one embodiment, the power-consumption requirement to achieve a desired battery-life of the wireless communication circuitry is between 0.01 and 0.5 Watts. In one embodiment, the low-power, wireless communication circuitry comprises Bluetooth Low-Energy circuitry and transmits and receives information directly from thermostat relay device 104 using Bluetooth Low-Energy communication protocols. In other embodiments, some other low-power wireless communication circuitry may be used, so long as the selected circuitry allows thermostat 106 to operate for long periods of time without requiring a battery change.

Thermostat relay device 104 acts as a communication hub, allowing end devices 110 to communicate with thermostat 106. Such communications may comprise “thermostatic” commands and responses that are particular to thermostats. For example, a thermostatic command may comprise an instruction from an end device 110 to program thermostat 106 to operate HVAC 112, or a command to retrieve certain information, such as current thermostat setpoints, current temperature(s) sensed by thermostat 106, and/or historical information, such as past performance of HVAC 112 to meet programmed setpoints, etc. Thermostatic responses may comprise confirmations of successful setpoint programming, temperature information, setpoint information, and/or historical temperature and/or performance data pertaining to HVAC, i.e., whether HVAC was able to heat or cool home 100 within a ramp time as defined by one of the setpoints.

Using low-power wireless communication circuitry and related protocols, thermostat 106 may be installed onto wall 108 without the need for a continuous source of power, as the low-power circuitry allows thermostat 106 to run off of one or more standard batteries for long periods of time without the need to replace the batteries. However, thermostat 106 must be mounted within range of thermostat relay device 104, i.e., the wireless communication range of a low-power transmitter within thermostat relay device 104.

In one embodiment, instead of using low-power RF circuitry and protocols such as Bluetooth Low-Energy, both thermostat relay device 104 and thermostat 106 may utilize other communication techniques, such as ultrasonic transceivers or photo-transceivers. In the case of ultrasound, each of thermostat relay device 104 and thermostat 106 may comprise an ultra-sonic transmitter/receiver pair, or transceiver, that transmits and receives ultra-sonic sound energy in accordance with a selected communication protocol. In the case of photo-transceivers, each of thermostat relay device 104 and thermostat 106 may comprise a transmitter that emits light and a receiver that is receptive to the light emitted by the transmitter, again in accordance with a selected protocol.

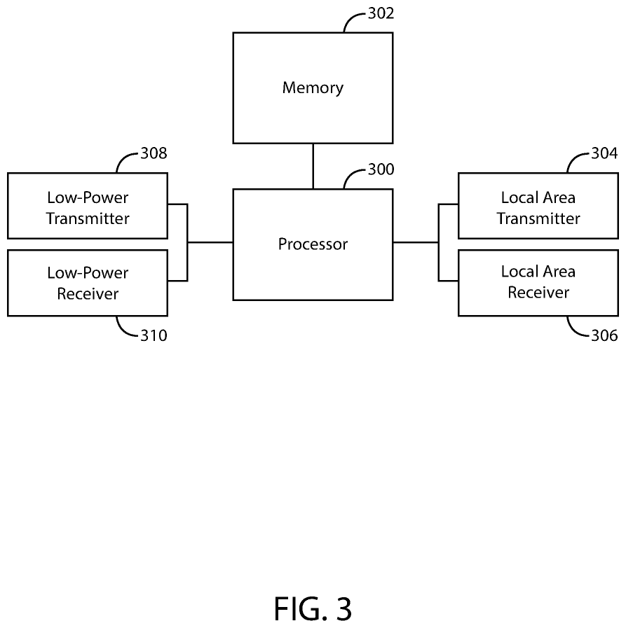

FIG. 3 is a functional block diagram of one embodiment of thermostat relay device 104. In this embodiment, thermostat relay device 104 comprises a housing comprising AC prongs that plus into socket 202 to provide power to thermostat relay device 104, as well as to physically secure thermostat relay device 104 to wall 108.

FIG. 3 shows processor 300, memory 302, local-area transmitter 304, local-area receiver 306, low-power transmitter 308 and low-power receiver 310. It should be understood that the functional blocks may be connected to one another in a variety of ways. Further, it should be understood that local-area transmitter 304 and local-area receiver 306 may be packaged as a single transceiver unit and, similarly, low-power transmitter 308 and low-power receiver 310 may be packaged as a single transceiver.

Processor 300 is configured to provide general operation of thermostat relay device 104 by executing processor-executable instructions stored in memory 302, for example, executable code. Processor 300 typically comprises a general purpose processor, such as an ADuC7024 analog microcontroller manufactured by Analog Devices, Inc. of Norwood Mass., although any one of a variety of microprocessors, microcomputers, and/or microcontrollers may be used alternatively. Processor 300 is typically selected based on factors such as package size, cost and performance.

Memory 302 comprises one or more information storage devices, such as RAM, ROM, flash memory, SD memory, XD memory, or virtually any other type of electronic, optical, or mechanical memory device. Memory 302 is used to store the processor-executable instructions for operation of thermostat relay device 104 as well as any information used by thermostat relay device 104 during operation of thermostat relay device 104. Memory 302 may, additionally or alternatively, be incorporated into processor 300.

Local-area transmitter 304 comprises circuitry necessary to transmit wireless communication signals from thermostat relay device 104 to local-area network 102 and, typically, onto an end device 110. Such communication signals may comprise thermostatic commands, such as requests for thermostat 106 to provide status information such as currently-programmed setpoints, ambient temperature information, historical information, such as past performance of HVAC 112 to meet programmed setpoints, etc. Such circuitry is well known in the art and may comprise Wi-Fi or RF circuitry, for example. Local-area transmitter 304 (in conjunction with local-area receiver 306) typically consumes more power than desirable if thermostat relay device 104 were to be powered by batteries, i.e., batteries would need to be replaced on a relatively frequent basis, such as once every three months. Local-area transmitter 304 may, alternatively or in addition, comprise well-known power-line circuitry to provide signals to a remote destinations via household AC wiring. Typical power output is between 11 and 30 dbm.

Local-area receiver 306 comprises circuitry necessary to receive wireless communication signals from local-area network 102. Such communication signals may comprise thermostatic commands, such as commands from end devices 110 to program thermostat 106, status requests, historical information requests, etc. Such circuitry is well known in the art and may comprise Wi-Fi or RF circuitry, for example. Local-area receiver 306 may, alternatively or in addition, comprise well-known power-line circuitry to receive signals from local-area network 102 via household AC wiring.

Low-power transmitter 308 comprises circuitry necessary to transmit low-power, wireless communication signals to thermostat 106. Such circuitry is well known in the art and may comprise Bluetooth Low-Energy, ANT, optical, or ultrasonic circuitry, among others. The communication signals comprise thermostatic commands. Typical power output is between 4 and 10 dbm. Typically, the transmit power of low-power transmitter 308 is much less than local-area transmitter 304, typically on the order of a factor of between 5 and 20, as measured in milliwatts.

Low-power receiver 310 comprises circuitry necessary to receive low-power, wireless communication signals from thermostat 106. Such circuitry is well known in the art and may comprise Bluetooth Low-Energy, ANT, optical, or ultrasonic circuitry, among others. The communication signals comprise thermostatic responses.

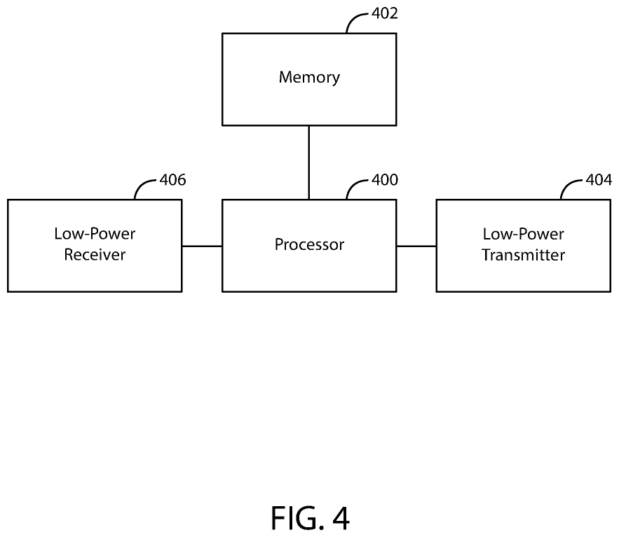

FIG. 4 is a functional block diagram of one embodiment of thermostat 106. In this embodiment, thermostat 106 is battery powered and physically coupled to wall 108 via traditional mounted methods, such as by using screws, mollies, etc. FIG. 4 shows processor 400, memory 402, low-power transmitter 404 and low-power receiver 406. It should be understood that the functional blocks may be connected to one another in a variety of ways. Further, it should be understood that low-power transmitter 404 and low-power receiver 406 may be packaged as a single transceiver. Finally, it should be understood that certain functional blocks have been omitted, such as a temperature sensor or a user interface, for clarity.

Processor 400 is configured to provide general operation of thermostat 106 by executing processor-executable instructions stored in memory 402, for example, executable code. Processor 400 typically comprises a general purpose processor, such as an ADuC7024 analog microcontroller manufactured by Analog Devices, Inc. of Norwood Mass., although any one of a variety of microprocessors, microcomputers, and/or microcontrollers may be used alternatively. Processor 400 is typically selected based on factors such as power consumption, package size, cost and performance.

Memory 402 comprises one or more information storage devices, such as RAM, ROM, flash memory, SD memory, XD memory, or virtually any other type of electronic, optical, or mechanical memory device. Memory 402 is used to store the processor-executable instructions for operation of thermostat 106 as well as any information used by thermostat 106 during operation of thermostat 106, such as time and temperature setpoints, status information, historical performance information, etc. Memory 402 may, additionally or alternatively, be incorporated into processor 400.

Low-power transmitter 404 comprises circuitry necessary to transmit low-power, wireless communication signals to thermostat relay device 104. Such circuitry is well known in the art and may comprise Bluetooth Low-Energy, ANT, optical, or ultrasonic circuitry, among others. The communication signals comprise thermostatic responses. Typical power output is between 4 and 10 dbm. Typically, the transmit power of low-power transmitter 404 is much less than local-area transmitter 304, typically on the order of a factor of between 5 and 20, as measured in milliwatts.

Low-power receiver 406 comprises circuitry necessary to receive low-power, wireless communication signals from thermostat relay device 104 using a low-energy wireless communication protocol. Such circuitry is well known in the art and may comprise Bluetooth Low-Energy, ANT, optical, or ultrasonic circuitry, among others. The communication signals comprise thermostatic commands.

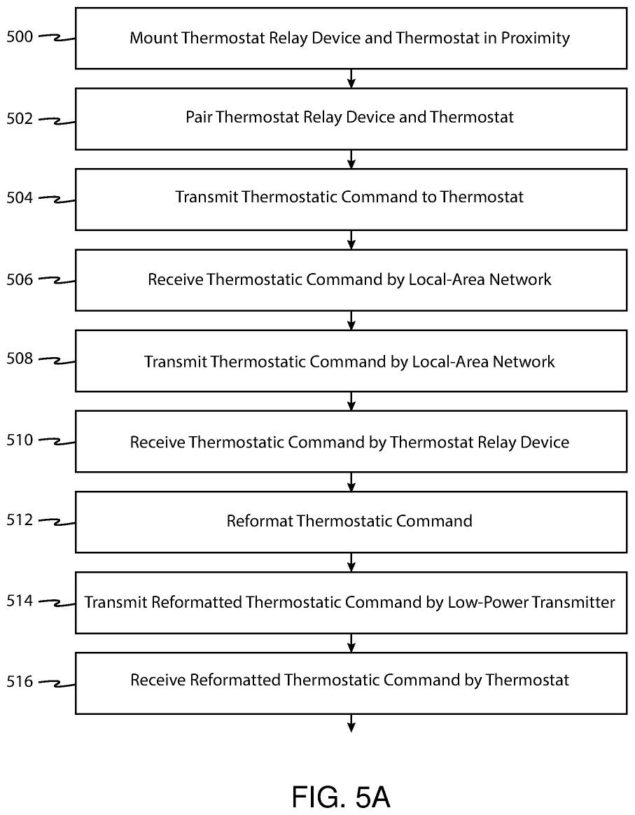

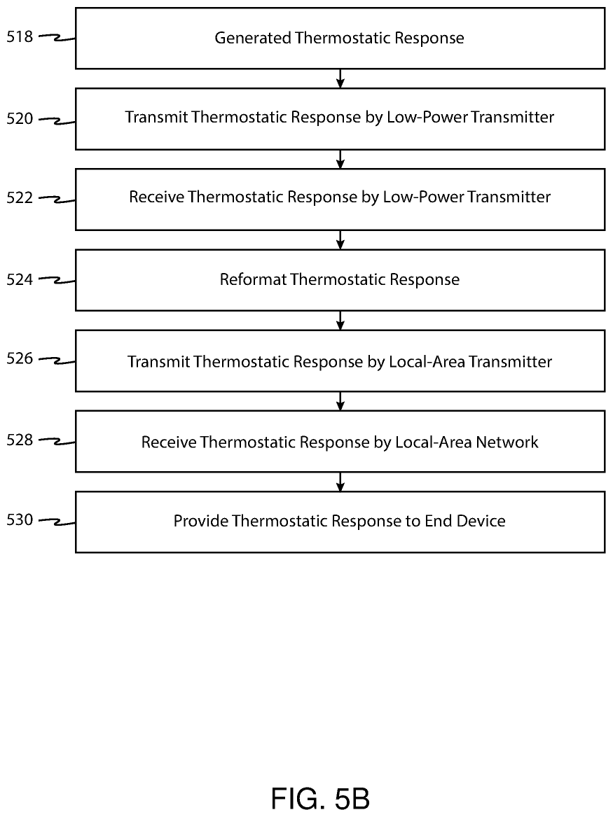

FIG. 5 is a flow diagram illustrating one embodiment of a method performed by thermostat 106 and thermostat relay device 104. It should be understood that in some embodiments, not all of the steps shown in FIG. 5 are performed. It should also be understood that the order in which the steps are carried out may be different in other embodiments.

At block 500, thermostat 106 and thermostat relay device 104 are mounted to wall 108 and socket 202, respectively. Thermostat 106 is located within range of low-power transmitter 308, typically between 3 feet and 10 feet.

At block 502, thermostat relay device 104 and thermostat 106 are both powered on, and “paired” with each other using techniques well-known in the art.

At block 504, a user communicates launches a software application or “app” on an end device 110, the app for providing the user with an easy-to-use user interface for set-up and control of thermostat 106. As such, end device 110 transmits a thermostatic command to thermostat 106 via local-area network 102 and thermostat relay device 104, such as to inquire as to the current temperature inside home 100 in proximity to thermostat 106 or to program thermostat 106 with “setpoints”, i.e., one or more temperatures and associated times to achieve the temperatures by HVAC 112.

At block 506, the thermostatic command is received by local-area network where it is reformatted in accordance with a local-area wireless communication protocol used by local-area network 102, such as one of several Wi-Fi protocols.

At block 508, the thermostatic command is transmitted by local-area network 102.

At block 510, the thermostatic command is received by local-area receiver 306 in thermostat relay device 104 and provided to processor 300.

At block 512, processor 300 formats the thermostatic command in accordance with a low-energy wireless communication protocol, such as Bluetooth LE.

At block 514, processor 300 causes local-area transmitter 304 to transmit the reformatted, thermostatic command to thermostat 106.

At block 516, low-power receiver 406 receives the reformatted thermostatic command and provides the thermostatic command to processor 400.

At block 518, processor 400 evaluates the thermostatic command and generates a thermostatic response based on the thermostatic command in accordance with the low-energy wireless communication protocol. For example, if the thermostatic command was for thermostat 106 to provide a current temperature reading, the thermostatic response comprises a current temperature as determined by processor 400 reading a digital thermostat coupled to processor 400. If the thermostatic command was to program thermostat 106 with setpoints, the thermostatic response comprises a status response as to whether or not the setpoints were successfully programmed. If the thermostatic command was to provide historical performance, setpoint or temperature information, the thermostatic response comprises historical data stored by processor 400 in memory 402.

At block 520, processor 400 causes the thermostatic response to be transmitted to thermostat relay device 104 via low-power transmitter 308.

At block 522, the thermostatic response is received by low-power receiver 310 inside thermostat relay device 104 and provided to processor 300.

At block 524, the thermostatic response is reformatted by processor 300 in accordance with the local-area wireless communication protocol.

At block 526, processor 300 causes the reformatted thermostatic response to be transmitted by transmitter 308.

At block 528, the reformatted thermostatic response is received by local-area network 102.

At block 530, the reformatted thermostatic response is provided to end device 110, using techniques well-known in the art.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a non-transitory processor-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A method implemented by a thermostat relay device, comprising:
wirelessly receiving, by a processor via a receiver coupled to the processor, a thermostatic command from a local-area network, the thermostat command received in accordance with a local-area wireless communication protocol, the thermostatic command for causing a battery-operated thermostat to perform an action; and
transmitting, by the processor via a low-power transmitter coupled to the processor, the thermostatic command using a low-energy wireless communication protocol to the battery-powered thermostat located within range of the low-power transmitter.

2. The method of claim 1, further comprising:
wirelessly receiving, by the processor via a low-power receiver coupled to the processor, a thermostatic response from the battery-powered thermostat in accordance with the low-energy wireless communication protocol; and
transmitting, by the processor via a transmitter coupled to the processor, the thermostatic response to the local-area network using the local-area wireless communication protocol.

3. The method of claim 1, wherein the local-area wireless communication protocol comprises a Wi-Fi protocol and the low-energy wireless communication protocol comprises a Bluetooth Low-Energy protocol.

4. The method of claim 1, wherein the thermostatic command comprises instructions to program the battery-operated thermostat with one or more setpoints.

5. The method of claim 1, wherein the thermostatic command comprises a request for information from the battery-operated thermostat.

6. The method of claim 5, wherein the information comprises a current temperature as sensed by the battery-operated thermostat.

7. The method of claim 5, wherein the information comprises historical temperature information stored by the battery-operated thermostat.

8. The method of claim 5, wherein the information comprises historical performance data of an HVAC system controlled by the battery-operated thermostat.

9. A thermostat relay device, comprising:
a memory for storing processor-executable instructions;
a receiver for wirelessly receiving a thermostatic command in accordance with a local-area wireless communication protocol; and
a low-power transmitter for transmitting a thermostatic response in accordance with a low-energy wireless communication protocol; and
a processor coupled to the memory, the receiver and the low-power transmitter for executing the processor-executable instructions that causes the thermostatic relay device to:
wirelessly receive, by the processor via the receiver, the thermostatic command from a local-area network, the thermostat command received in accordance with the local-area wireless communication protocol, the thermostatic command for causing a battery-operated thermostat to perform an action; and
transmit, by the processor via the low-power transmitter, the thermostatic command using the low-energy wireless communication protocol to the battery-powered thermostat located within range of the low-power transmitter.

10. The thermostat relay device of claim 9, further comprising:
a low-power receiver coupled to the processor for wirelessly receiving a thermostatic response from the battery-powered thermostat in accordance with the low-energy wireless communication protocol; and
a local-area transmitter coupled to the processor for transmitting the thermostatic response to the local-area network using the local-area wireless communication protocol.

11. The thermostat relay device of claim 9, wherein the local-area wireless communication protocol comprises a Wi-Fi protocol and the low-energy wireless communication protocol comprises a Bluetooth Low-Energy protocol.

12. The thermostat relay device of claim 9, wherein the thermostatic command comprises instructions to program the battery-operated thermostat with one or more setpoints.

13. The thermostat relay device of claim 9, wherein the thermostatic command comprises a request for information from the battery-operated thermostat.

14. The thermostat relay device of claim 13, wherein the information comprises a current temperature as sensed by the battery-operated thermostat.

15. The thermostat relay device of claim 13, wherein the information comprises historical temperature information stored by the battery-operated thermostat.

16. The thermostat relay device of claim 13, wherein the information comprises historical performance data of an HVAC system controlled by the battery-operated thermostat.
